(19) United States
(12) Patent Application Publication
(10) Pub. No.: US 2012/0039356 A1
(43) Pub. Date: Feb. 16, 2012

(54) MULTI-PROBE MEAT THERMOMETER

(76) Inventors: Charles Adams, Berkeley, CA (US); Cory Thomas Borovicka, Oakland, CA (US)

(21) Appl. No.: 13/210,298

(22) Filed: Aug. 15, 2011

Related U.S. Application Data
(63) Continuation-in-part of application No. 29/357,202, filed on Mar. 9, 2010.
(60) Provisional application No. 61/373,787, filed on Aug. 13, 2010.

(51) Int. Cl. G01K 13/00

(52) U.S. Cl. 374/155; 374/E13.001

(57) ABSTRACT

A temperature sensing and display system is provided for simultaneously monitoring the doneness of different pieces of meat or different portions of a piece of meat being cooked or grilled. The temperature sensing and display system includes a base unit having a temperature display and a plurality of temperature monitoring inputs. A plurality of temperature probes are provided that connect to the different temperature inputs of the base unit.

### CROSS-REFERENCE TO RELATED APPLICATIONS

This is a continuation-in-part application of U.S. Design Patent Application No. 29/357,202, filed Mar. 9, 2010, now pending. This application also claims the benefit of U.S. Provisional Patent Application No. 61/373,787 filed Aug. 13, 2010. Both of the foregoing applications are incorporated herein by reference and made a part hereof.

### FIELD OF INVENTION

The present invention generally relates to thermometers, and more particularly, to cooking thermometers used to measure the temperature of meats while they are cooking on a barbeque grill.

### SUMMARY OF INVENTION

A temperature sensing and display system is provided for simultaneously monitoring the doneness of different pieces of meat or different portions of a piece of meat being cooked or grilled. The temperature sensing and display system includes a base unit having a temperature display and a plurality of temperature monitoring inputs. A plurality of temperature probes are provided that connect to the different temperature inputs of the base unit. Each of the temperature probes is comprised of a base end, a meat piercing end, and an elongated flexible member connecting the meat piercing end to the base end. The meat piercing end is adapted to sense the localized temperature of a piece of meat into which it is inserted, and the elongated flexible member is adapted to transmit meat temperature information collected by the meat piercing end to the base end of the temperature probe. The base end of each of said temperature probes is connected or connectable to one of the temperature monitoring inputs of the base unit, wherein the temperature monitoring inputs of the base unit simultaneously receive different meat temperature indications corresponding to the sensed temperature of different pieces of meat or portions of a piece of meat into which the meat piercing ends of the temperature probes are inserted.

The temperature display of said base unit has a doneness indication portion or section associated with each temperature monitoring input of the base unit. Each of the doneness indication portions or sections of the temperature display is responsive to meat temperature indications received from the temperature probes connected to the temperature inputs of the base unit. The doneness indication sections of the temperature display will display, and preferably simultaneously display, an indication of the doneness of each piece of meat or each portion of a piece of meat into which the meat piercing ends of the temperature probes are inserted.

In a further and separate aspect of the invention, the plurality of temperature probes provided with the base unit can be removably plugged into the base unit and can be stowed in the base unit when not in use.

In another and separate aspect of the invention, the temperature probes can be color coded or provided with other means of visually distinguishing one temperature probe from another so that a particular temperature probe can be readily associated with a particular display section on the base unit.

Thus, using a temperature sensing and display system in accordance with the invention, the degree of doneness of different pieces of meat cooking on a barbeque can be monitored at the same time by a single monitoring unit. Separate monitoring units are not required. A compact monitoring station can be provided the can be easily used and with easily storable temperature probes.

### DESCRIPTION OF THE DRAWINGS

FIG. 1 is a pictorial illustration of a multi-probe meat thermometer in accordance with the invention, showing the thermometer being used to monitor the temperature of different pieces of meat being grilled on a barbeque.

FIG. 2 is a top perspective view of a multi-probe meat thermometer in accordance with the invention.

FIG. 3 is a top plan view thereof, illustrating an exemplary display for displaying the relative doneness of different pieces of meat (or of the same piece of meat at different locations) as sensed by the different temperature probes of the multi-probe meat thermometer.

FIG. 4 is a top perspective view of the base unit of the multi-probe meat thermometer shown in the foregoing figures.

FIG. 5 is a back end elevational view thereof.

FIG. 6 is a front end elevational view thereof.

FIG. 7 is a bottom plan view thereof.

FIG. 8 is a bottom perspective view thereof.

FIG. 9 is another bottom perspective view thereof, showing the temperature probes of the meat thermometer stowed in the base unit and the extension lines of the temperature probes wrapped around the line wrapping brackets on the base unit stand.

FIG. 10 is an exploded top perspective view of the multi-probe meat thermometer shown in the foregoing figures.

FIG. 11 is a graphical illustration of an exemplary temperature sensing circuit for the multi-probe meat thermometer shown in the foregoing figures.

### DESCRIPTION OF THE ILLUSTRATED EMBODIMENTS

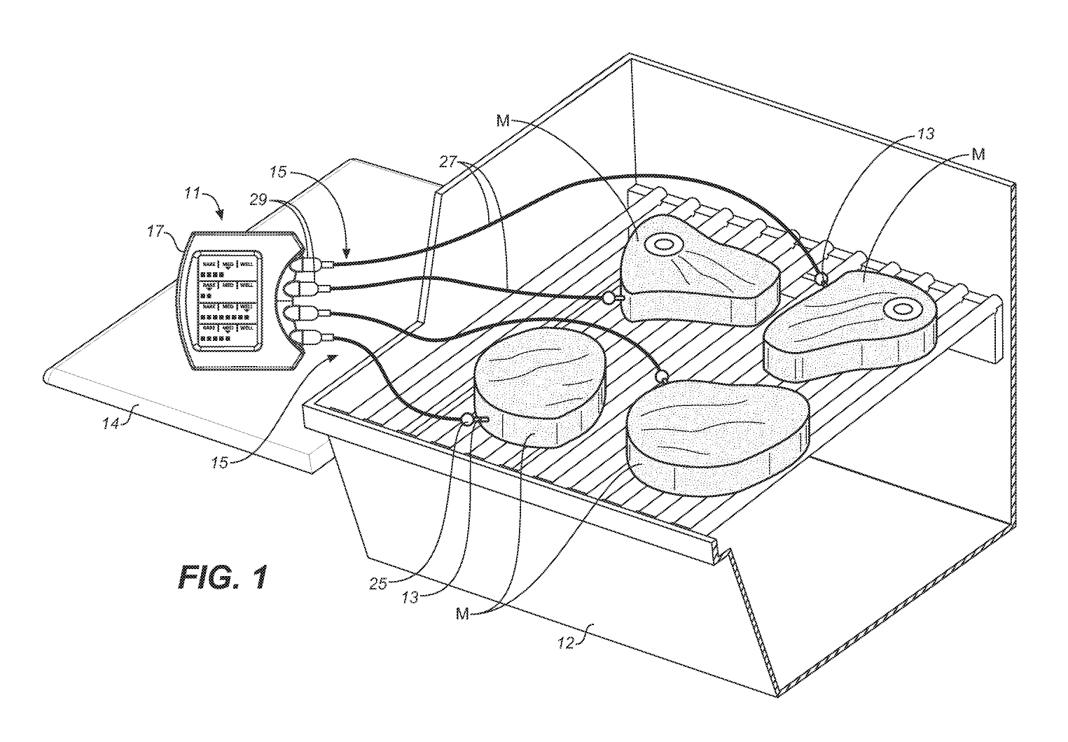

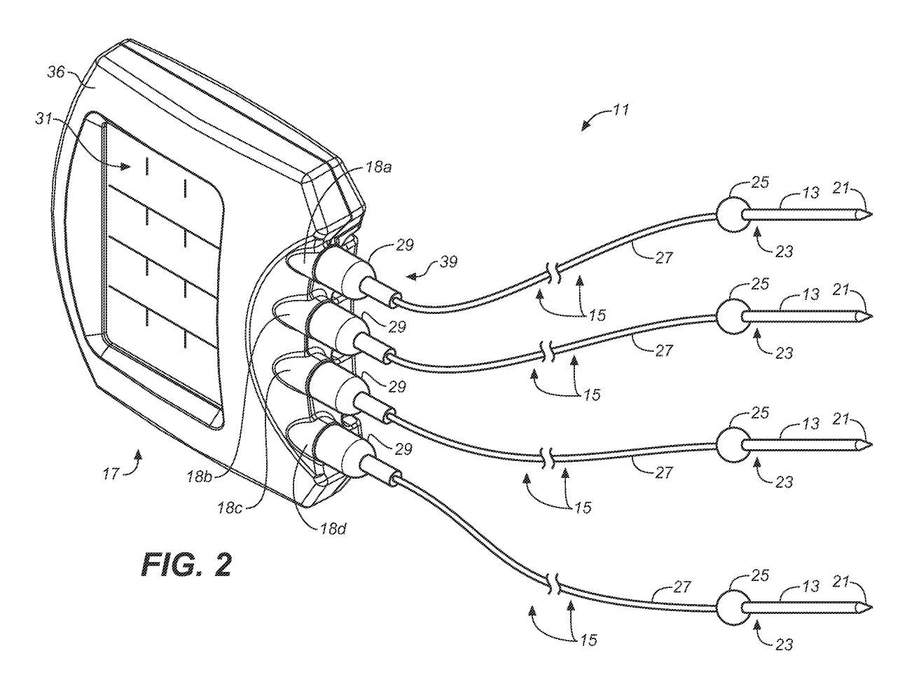

Referring now to the drawings, FIG. 1 shows a temperature sensing and display system 11 simultaneously monitoring the internal temperature of pieces of meat M being cooked on a barbeque grill 12, and indicating the relative “doneness” of the each piece of meat being monitored. While FIG. 1 shows the meat thermometer monitoring the internal temperature of the different pieces meat at a single location within the meat, the thermometer could also be used to monitor the internal temperature of single piece of meat at different locations, or to monitor the internal temperature of one piece of meat at different locations and another piece of meat at a single location.

The temperature sensing and display system includes multiple temperature probes 15 and a base unit 17, The base unit has multiple temperature signal inputs, suitably in the form of inputs jacks 18a, 18b, 18c, 18d, to which the temperature probes can be connected. Each of the temperature probes is comprised of a probe tip 13, a flexible conductive probe extension line 27, and a plug end 29 that removably plugs into one of the base unit's input jacks. While plug and jack connectors are shown for connecting the multiple probes to the base unit, other means of connecting the multiple probes to the base unit are considered within the scope of the invention, even including temperature probes that are connected by means of a permanent connection. Also, while four temperature probes and four input jacks on the base unit are shown, it will be understood that more or fewer (but at least two) probes and more or fewer base unit input jacks (but at least two input jacks) for the probes can be provided. Suitably, the number of available temperature probes will equal the number of base unit input jacks.

The probe tip 13 of each temperature probe 15 can be a rigid elongated element that has a tapered meat piercing end 21 and a base end 23. The probe tips contain temperature sensors for sensing the temperature of the meat into which they are inserted and are constructed of a thermally-conductive material, such as stainless steel.

A visually prominent probe Lip marker structure is preferably provided at the base end 23 of each probe tip. The marker structures can be visually coded so that one probe can be distinguished from another probe and so that the probe tip of any one of the probes can be visually associated with the base unit input jack to which is connected. For example, the probe tip marker structures can be similarly sized marker balls 25 as shown in the drawings, each of which is color-coded. The plug ends 29 of the temperature probes and/or the base unit input jacks 18a-18d can have corresponding color-coding to allow any of the probes to be readily associated with an input jack. Other visual coding schemes would be possible, such as differently shaped probe tip markers which correspond to probe plug ends provided with correspondingly shaped visual marker structures. The marker structures 25 can be fabricated from a thermally tolerant material such as high temperature rated silicone.

As illustrated in FIG. 1, the flexible extension lines 27 of the temperature probes 15 can have sufficient length to allow the base unit 17 to be placed at a location remote from the probe tips when the probe tips are inserted into meat M on the barbeque grill 12. Typically, the base unit would be placed on an adjacent shelf 14 of a barbeque unit, but could be set or suspended from other structures on or in the vicinity of the barbeque. The probe extension lines can suitably be fabricated of braided stainless steel wires or other materials capable of conveying meat temperature information collected at the probe tips to the plug ends 29 of the temperature probes.

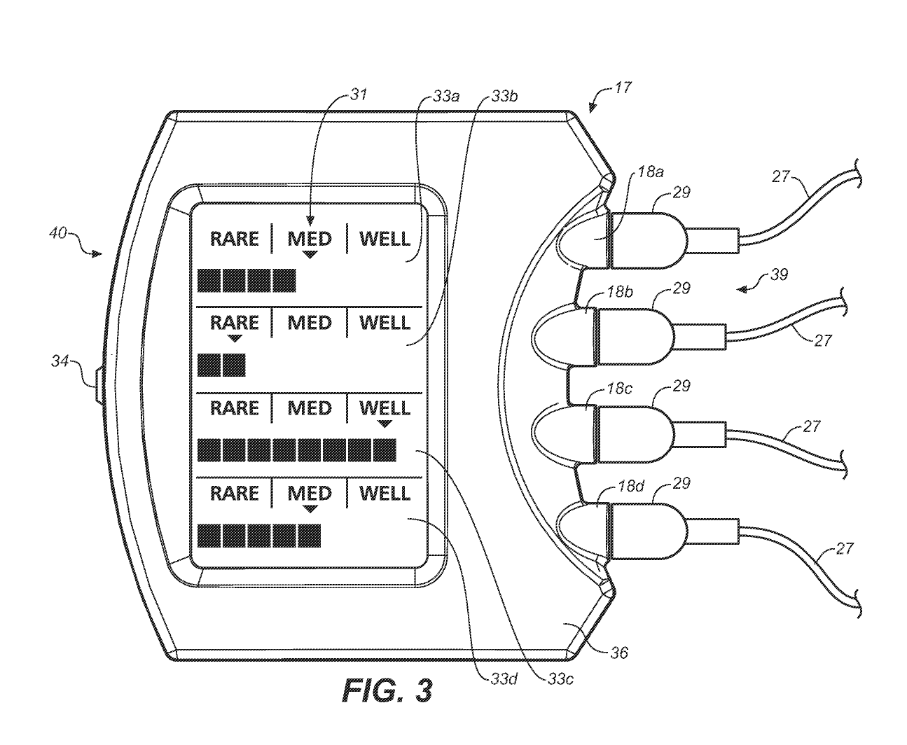

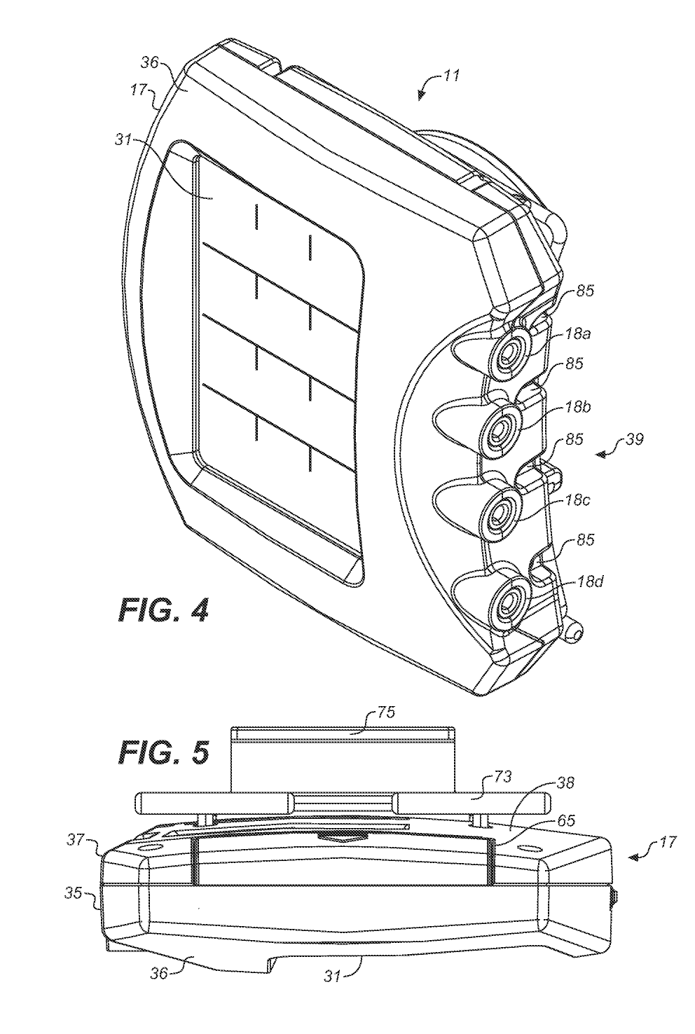

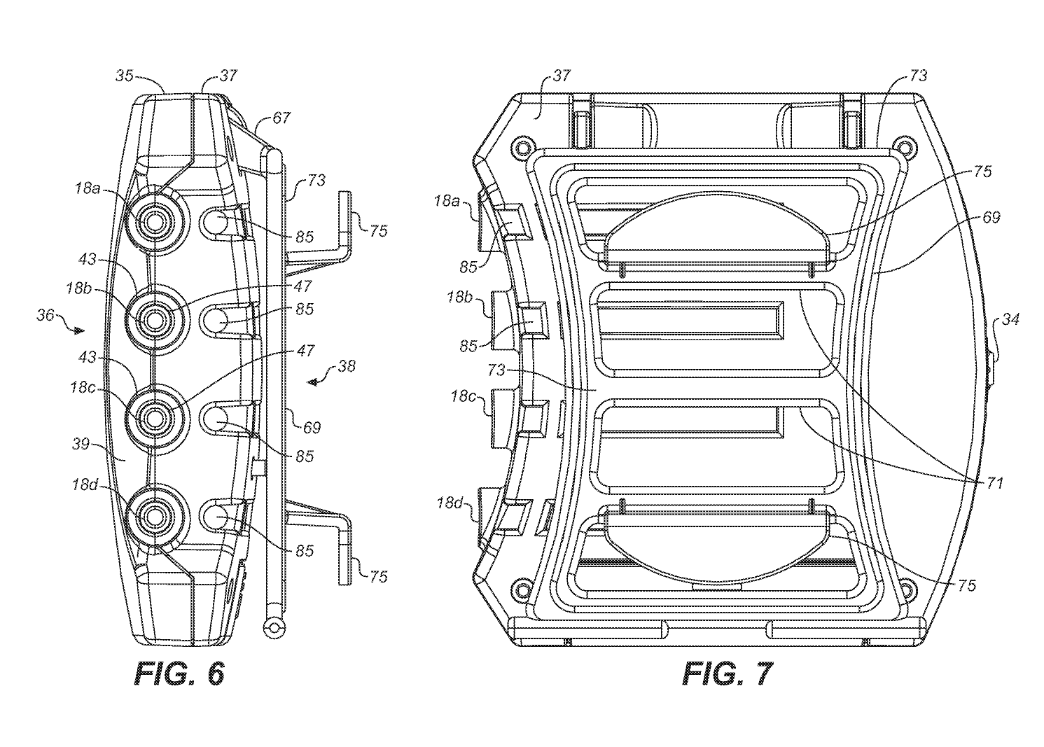

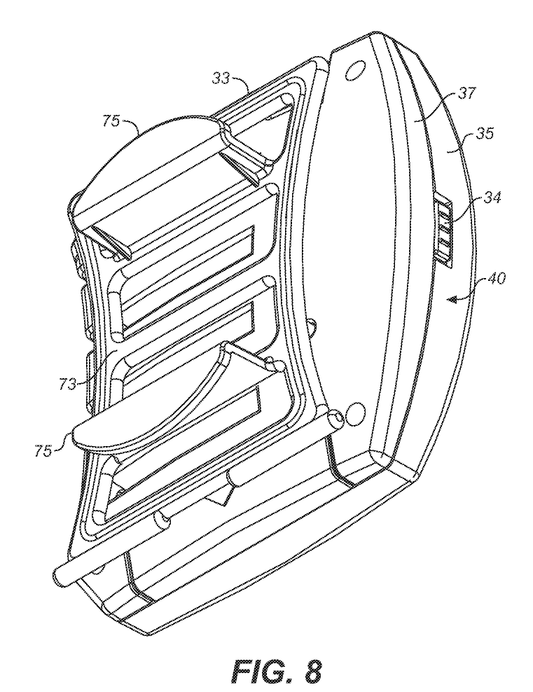

As best shown in FIG. 3, the base unit 17 can include a display 31 responsive to temperature inputs received from the temperature probes 15 that are connected to the base unit. The base unit display 31 displays the degree of doneness of each piece of meat M being cooked and temperature-monitored on the barbeque grill. In the illustrated embodiment a single display window 32 is provided with a display that is divided into separate “doneness” indicator display portions or sections 33a, 33b, 33c, 33d, with one display section being associated with each base unit input jack 18. Each display section registers the degree of doneness for one of the pieces of meat being monitored. For ease in visually determining which display section is registering the degree of doneness of which piece of meat, the display sections are preferably arranged in a stack relationship so that each section is positioned immediately adjacent the base unit input jack receiving the temperature information it is registering. Thus, for example, as best seen in FIG. 3, the top doneness indicator display section 33a would register a degree of doneness corresponding to the temperature input to base unit input jack 18a. Similarly, doneness indicator display section 33b would register a degree of doneness corresponding to the temperature input to base unit input jack 18b, and so on.

As also shown in FIG. 3, doneness indications in each display section can be provided in the form of an incremental bar display that expands with an increase in the sensed meat temperature. The temperature bar for each display section can be calibrated to temperature inputs from the temperature probes that correspond to the internal temperature of the piece of being monitored. In FIG. 3, each display section includes indications above the temperature bar of three degrees of doneness, namely, “RARE,” “MED” (for medium), and “WELL” (for well done). Temperature calibrations for the bar display would calibrate sensed temperature to these doneness indications for a particular type of meat, for example, beef. Separate calibrations could be provided for different base units used to monitor different types of meat, for example pork; also, as further described below, means could be provided in the base unit to change the calibrations for all or selected display sections of the base unit to allow a single base unit to monitor different kinds of meat at different times or at the same time.

FIG. 3 is but an example of the degree of doneness indications that could be provided by the base unit. Finer gradations could be added, such as medium rare and medium well, and/or actual internal meat temperatures could be displayed. Other indications of measured internal meat temperatures could include changing color displays in each display section, such as green for rare, yellow for medium, and red for well done.

Furthermore, it is contemplated that the display 31 could be provided, instead of in a single display window 32 as shown, in multiple display windows, for example in a separate display window associated with each base unit input jack 18a-18d. It is still further contemplated that the temperature information received at each of the base unit's temperature inputs could be relayed to a remote monitoring or alarm device. Also, while the doneness indication sections of the base unit display 31 preferably simultaneously displays doneness indications associated with the different temperature inputs received by the base unit, it is contemplated that the base unit could display doneness indications at different staggered times, and that in this case that the doneness indication sections could appear at the same location within the display window, that is, overlap.

The base unit 17 can be a relatively compact unit having a top face 36 with the above-described display window 32, a bottom face 38 having a stand 73 pivotally connected thereto, a front temperature probe plug-in end 39 for the base unit input jacks 33a-33d, and a back end 40, which can include an on-off switch 34.

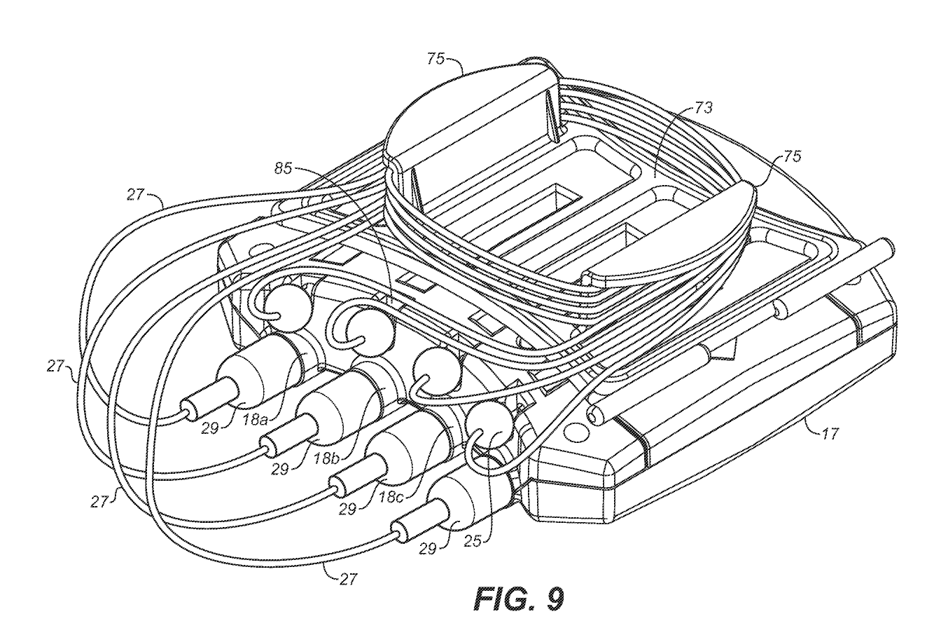

The base unit of the illustrated embodiment can also uniquely include means for stowing the temperature probes on the base unit when not in use. This stowing means include stow channels 85 in the plug-in end 39 of the base unit beneath the base unit input plugs, and opposed outwardly extending L-brackets 75 projecting from the back of the stand on connected to the back face of the base unit. As shown in FIG. 9, to stow the temperature probes the probes extension lines 27 are wrapped around the L-brackets and the probe tips 13 inserted into the stow channels 85 located beneath the base unit input jacks for the temperature probes. This can be done while the plug ends 29 of the temperature probes remain plugged into the base unit input jacks.

The number of stow channels in the base unit will preferably correspond to the number of temperature probes provided with the meat thermometer.

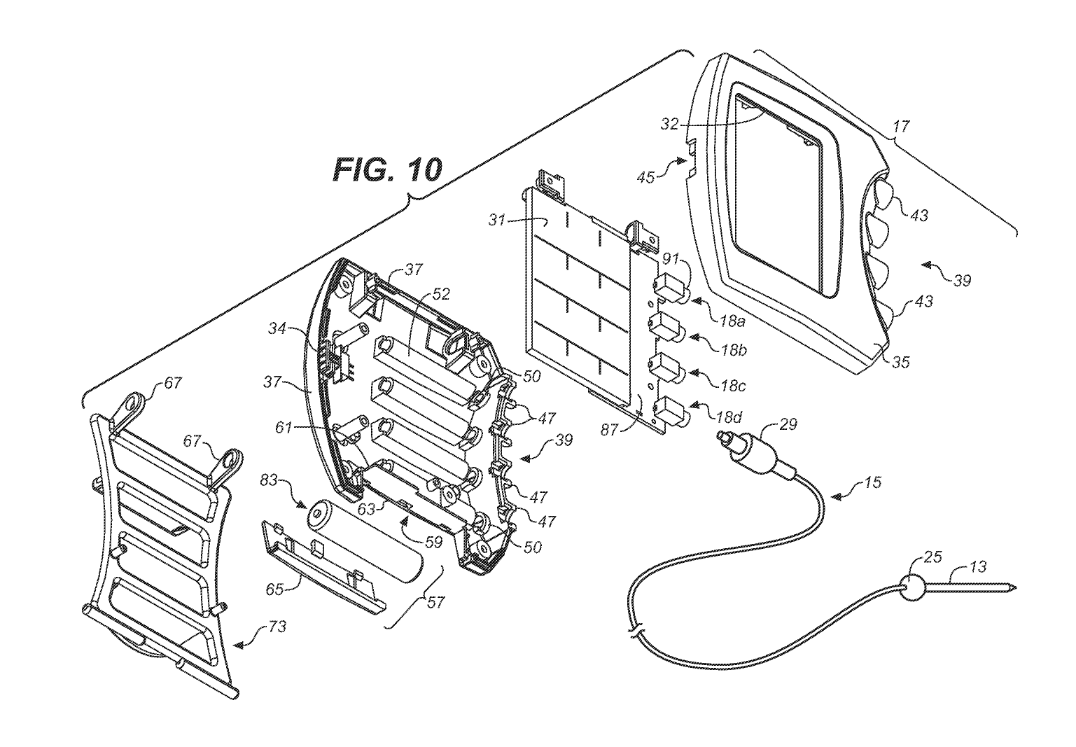

A suitable construction of the base unit 17 is illustrated in FIG. 10. The base unit will suitably have a casing of a thermally resistant plastic, which houses a printed circuit board 87 and display 31. The input jacks 18a-18d of the base unit can be mounted to the front edge of the PC board and the display can suitably be an LCD display that is mounted to or a part of the PC board. The casing can be formed by top and bottom covers 35, 37, each having a front edge 39 with semi-circular projections 43, 45, which form projecting surrounds for the base unit input jacks 18a-18d when the front and back covers are joined together. The top cover 35 has an opening 32 forming the front display window, and a cutout 45 on the back edge for the on-off switch 34. The bottom cover has front end openings 50 and internal elongated tubular encasement structures 52, which together provide the base unit stow channels 85. The base unit also includes a battery compartment 57 for a battery 83. The battery compartment 57 is formed by means of a rectangularly shaped cutout 59 in a side edge of the back cover, a wall 61 that extends upward from the cutout's back edge 63, and a removable battery compartment cover 65 that snap fits into the cutout 59.

The base unit's stand 73 is pivotally connected to the back cover 37 of the base unit casing 31 by pivot arms 67. The stand 73 can be in the form of an open frame structure having side rails 69 and cross bars 71. The front and back covers 35, 37, and the stand 73, can be fabricated from a commercially available heat-resistant plastic, or other suitable material.

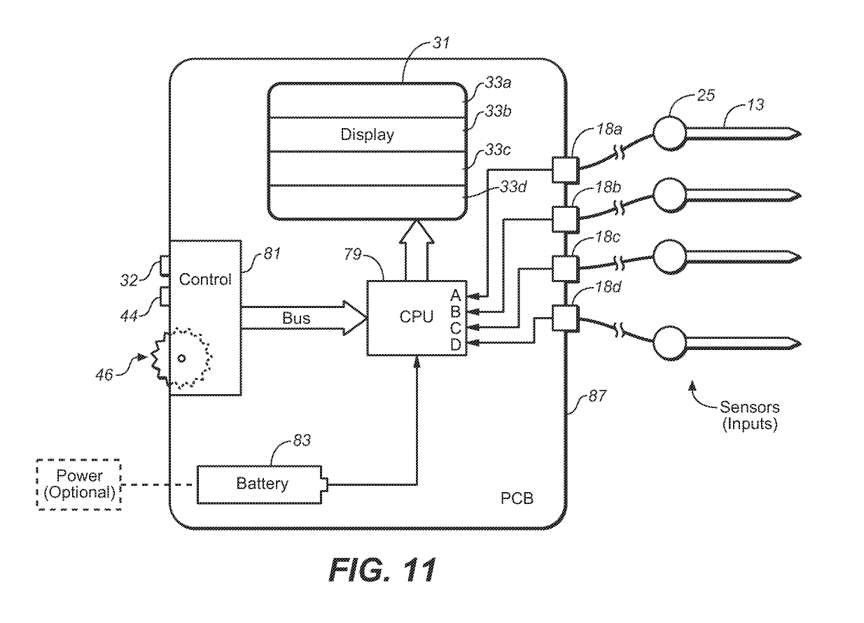

FIG. 11 graphically depicts an exemplary circuit for driving the base unit display 31 in response to temperature inputs to the base unit input jacks 18a-18d. FIG. 11 also provides a graphical representation of switching controls that might be added to the base unit to allow different types of meat to be monitored. FIG. 11 further shows an optional power external power supply in lieu of or in addition to battery 83.

With further reference to FIG. 11, the printed circuit board 87 can include a central processing unit (CPU) 79 and a control portion 81 through which the base unit display can be switched on and off, and through which display outputs can be switched between different types of meat that may be monitored via the temperature probes. The inclusion of an on-off switch is graphically represented by button 42, and a meat selection feature is graphically represented by the addition of a doneness display selection button 44 and a meat selection dial switch 46.

As illustrated in FIG. 11, the CPU inputs A,B,C,D receive temperature inputs from temperature probes denoted A,B,C,D, and drive the doneness indicator display sections 33a, 33b, 33c, 33d of the display 31. Each of doneness indicator display sections can be switched to indicate the doneness of different types of meats via a display section selection switch 44 and meat selection dial switch 46. Each doneness indicator display section can also have means (not shown) for indicating the display section has been selected, for example, a selection icon or light that displays only when the display section is selected. The selection switch can repeatedly be pushed to advance the selection from one doneness indicator display section to the next. When a doneness indicator display section is selected, the meat type for the temperature probe associated with the display section can be changed via meat selection dial switch 46.

While the present invention has been described in considerable detail in the foregoing specification and accompanying drawings, it is not intended that the invention be limited to such detail, except as necessitated by the following claims.

What we claim is:

1. A temperature sensing and display system for simultaneously monitoring the doneness of different pieces of meat or different portions of a piece of meat being cooked or grilled, said temperature sensing and display system comprising:
a base unit having a temperature display and a plurality of temperature monitoring inputs, and
a plurality of temperature probes, each of which comprises a base end, a meat piercing end, and an elongated flexible member connecting the meat piercing end to the base end; the meat piercing end being adapted to sense the local temperature of a piece of meat into which it is inserted, and the elongated flexible member being adapted to transmit meat temperature information collected by said meat piercing end to the base end of the temperature probe,
the base end of each of said temperature probes being connected to one of the temperature monitoring inputs of said base unit, wherein the temperature monitoring inputs of the base unit simultaneously receive different meat temperature indications corresponding to the sensed temperature of different pieces of meat or portions of a piece of meat into which the meat piercing ends of the temperature probes are inserted,
the temperature display of said base unit having a doneness indication portion associated with each temperature monitoring input of the base unit, and being responsive to meat temperature indications received from the temperature probes connected to the temperature inputs of the base unit, wherein the doneness indication portions of the temperature display display an indication of the doneness of each piece of meat or each portion of a piece of meat into which the meat piercing ends of the temperature probes are inserted.

2. The temperature sensing and display system of claim 1 wherein the doneness indication portions of the temperature display of said base unit simultaneously display the indications of the doneness of each piece of meat or each portion of a piece of meat.

3. The temperature sensing and display system of claim 1 wherein the base end of each of said temperature probes is removably connected to the temperature monitoring inputs of said base unit.

4. The temperature sensing and display system of claim 1 wherein each doneness indication portion of the temperature display of said base unit includes indicia indicating at least three levels of doneness of the meat at the location where the meat piercing end of the temperature probe is inserted.

5. The temperature sensing and display system of claim 1 wherein each doneness indication portion of the temperature display of said base unit is located adjacent its associated temperature monitoring input for visually associating the doneness indication produced by said doneness indication portion with a particular temperature probe.

6. The temperature sensing and display system of claim 1 wherein the doneness indication portions of the temperature display of said base unit are comprised of parallel temperature bars, the lengths of which visually indicate the relative degrees of doneness of each piece of meat or each portion of a piece of meat being monitored.

7. The temperature sensing and display system of claim 1 wherein said base unit has at least four temperature monitoring inputs and a temperature probe for each of said inputs.

8. The temperature sensing and display system of claim 1 wherein said base unit includes at least one stow channel sized to receive and removably hold the meat piercing end of at least one of the plurality of temperature probes for stowing same in the base unit when not in use.

9. The temperature sensing and display system of claim 8 wherein the base unit has a stow channel for the meat piercing end of each temperature probe.

10. The temperature sensing and display system of claim 1 wherein visual association means are provided at or proximate the meat piercing end and at or proximate the base end of each temperature probe for providing a visual association between the meat piercing end of the temperature probe and the meat pierced thereby and the temperature monitoring inputs of the base unit, such that the reading on each doneness indication portion associated with each temperature monitoring input can be readily associated with a particular temperature probe.

11. The temperature sensing and display system of claim 1 wherein the visual association means includes color-coded structures at or proximate the meat piercing end and at or proximate the base end of the temperature probes.

12. A temperature sensing and display system for simultaneously monitoring the doneness of different pieces of meat or different portions of a piece of meat being cooked or grilled, said temperature sensing and display system comprising:
a base unit having a temperature display and a plurality of temperature monitoring inputs, and
a plurality of temperature probes, each of which comprises a base end, a meat piercing end, and an elongated flexible member connecting the meat piercing end to the base end, the meat piercing end being adapted to sense the local temperature of a piece of meat into which it is inserted, and the elongated flexible member being adapted to transmit meat temperature information collected by said meat piercing end to the base end of the temperature probe,
the base end of each of said temperature probes being removably connectable to one of the temperature monitoring inputs of said base unit, wherein the temperature monitoring inputs of the base unit simultaneously receive different meat temperature indications corresponding to the sensed temperature of different pieces of meat or portions of a piece of meat into which the meat piercing ends of the temperature probes are inserted,
the temperature display of said base unit having a doneness indication portion associated with each temperature monitoring input of the base unit, and being responsive to meat temperature indications received from the temperature probes connected to the temperature inputs of the base unit, wherein the doneness indication portions of the temperature display simultaneously display an indication of the doneness of each piece of meat or each portion of a piece of meat into which the meat piercing ends of the temperature probes are inserted, and
wherein visual association means are provided at or proximate the meat piercing end and at or proximate the base end of each temperature probe for providing a visual association between the meat piercing end of the temperature probe and the meat pierced thereby and the temperature monitoring inputs of the base unit, such that the reading on each doneness indication portion associated with each temperature monitoring input can be readily associated with a particular temperature probe.

13. The temperature sensing and display system of claim 12 wherein the visual association means includes color-coded structures at or proximate the meat piercing end and at or proximate the base end of the temperature probes.

14. The temperature sensing and display system of claim 1 wherein said base unit includes at least one stow channel sized to receive and removably hold the meat piercing end of at least one of the plurality of temperature probes for stowing same in the base unit when not in use.
